(19) United States
(12) Patent Application Publication
(10) Pub. No.: US 2024/0073900 A1
(43) Pub. Date: Feb. 29, 2024

(54) SIDELINK BEAM HOPPING

(71) Applicant: QUALCOMM Incorporated, San Diego, CA (US)

(72) Inventors: Hua WANG, Basking Ridge, NJ (US); Sony AKKARAKARAN, Poway, CA (US); Tianyang BAI, Somerville, NJ (US); Yan ZHOU, San Diego, CA (US); Jung Ho RYU, Fort Lee, NJ (US); Tao LUO, San Diego, CA (US); Junyi LI, Fairless Hills, PA (US)

(21) Appl. No.: 17/822,324

(22) Filed: Aug. 25, 2022

(51) Int. Cl. H04W 72/04; H04W 72/02; H04W 72/08

(52) U.S. Cl. CPC H04W 72/0406; H04W 72/02; H04W 72/046; H04W 72/085

(57) ABSTRACT

Various aspects of the present disclosure generally relate to wireless communication. In some aspects, a transmitter user equipment (UE) may identify a plurality of beams that are configured for transmitting one or more sidelink communications via one or more sidelink resources. The UE may transmit sidelink control information that indicates to reserve the one or more sidelink resources and that includes an explicit beam indication or a beam hopping indication associated with the plurality of beams. Numerous other aspects are described.

### FIELD OF THE DISCLOSURE

Aspects of the present disclosure generally relate to wireless communication and to techniques and apparatuses for sidelink beam hopping.

### DESCRIPTION OF RELAYED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LYE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a transmitter user equipment (UE). The method may include identifying a plurality of beams that are configured for transmitting one or more sidelink communications via one or more sidelink resources. The method may include transmitting sidelink control information that indicates to reserve the one or more sidelink resources and that includes an explicit beam indication or a beam hopping indication associated with the plurality of beams.

Some aspects described herein relate to a method of wireless communication performed by a receiver UE. The method may include performing one or more measurements associated with a plurality of beams for receiving one or more sidelink communications. The method may include autonomously initiating a beam hopping based at least in part on the one or more measurements and based at least in part on one or more rules or information received from a transmitter UE.

Some aspects described herein relate to an apparatus for wireless communication performed by a transmitter UE. The apparatus may include a memory and one or more processors, coupled to the memory. The one or more processors may be configured to identify a plurality of beams that are configured for transmitting one or more sidelink communications via one or more sidelink resources. The one or more processors may be configured to transmit sidelink control information that indicates to reserve the one or more sidelink resources and that includes an explicit beam indication or a beam hopping indication associated with the plurality of beams.

Some aspects described herein relate to an apparatus for wireless communication performed by a receiver UE. The apparatus may include a memory and one or more processors, coupled to the memory. The one or more processors may be configured to perform one or more measurements associated with a plurality of beams for receiving one or more sidelink communications. The one or more processors may be configured to autonomously initiate a beam hopping based at least in part on the one or more measurements and based at least in part on one or more rules or information received from a transmitter UE.

Some aspects described herein relate to a non-transitory computer-readable medium that stores a set of instructions for wireless communication by a transmitter UE. The set of instructions, when executed by one or more processors of the UE, may cause the UE to identify a plurality of beams that are configured for transmitting one or more sidelink communications via one or more sidelink resources. The set of instructions, when executed by one or more processors of the UE, may cause the UE to transmit sidelink control information that indicates to reserve the one or more sidelink resources and that includes an explicit beam indication or a beam hopping indication associated with the plurality of beams.

Some aspects described herein relate to a non-transitory computer-readable medium that stores a set of instructions for wireless communication by a receiver UE. The set of instructions, when executed by one or more processors of the UE, may cause the UE to perform one or more measurements associated with a plurality of beams for receiving one or more sidelink communications. The set of instructions, when executed by one or more processors of the UE, may cause the UE to autonomously initiate a beam hopping based at least in part on the one or more measurements and based at least in part on one or more rules or information received from a transmitter UE.

Some aspects described herein relate to an apparatus for wireless communication. The apparatus may include means for identifying a plurality of beams that are configured for transmitting one or more sidelink communications via one or more sidelink resources. The apparatus may include means for transmitting sidelink control information that indicates to reserve the one or more sidelink resources and that includes an explicit beam indication or a beam hopping indication associated with the plurality of beams.

Some aspects described herein relate to an apparatus for wireless communication. The apparatus may include means for performing one or more measurements associated with a plurality of beams for receiving one or more sidelink communications. The apparatus may include means for autonomously initiating a beam hopping based at least in part on the one or more measurements and based at least in part on one or more rules or information received from a transmitter UE.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of sidelink resource allocation, in accordance with the present disclosure.

FIG. 6 is a diagram illustrating an example of sidelink beam hopping, in accordance with the present disclosure.

FIG. 7 is a diagram illustrating an example of sidelink beam hopping, in accordance with the present disclosure.

FIG. 8 is a diagram illustrating an example process performed, for example, by a transmitter UE, in accordance with the present disclosure.

FIG. 9 is a diagram illustrating an example process performed, for example, by a receiver UE, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

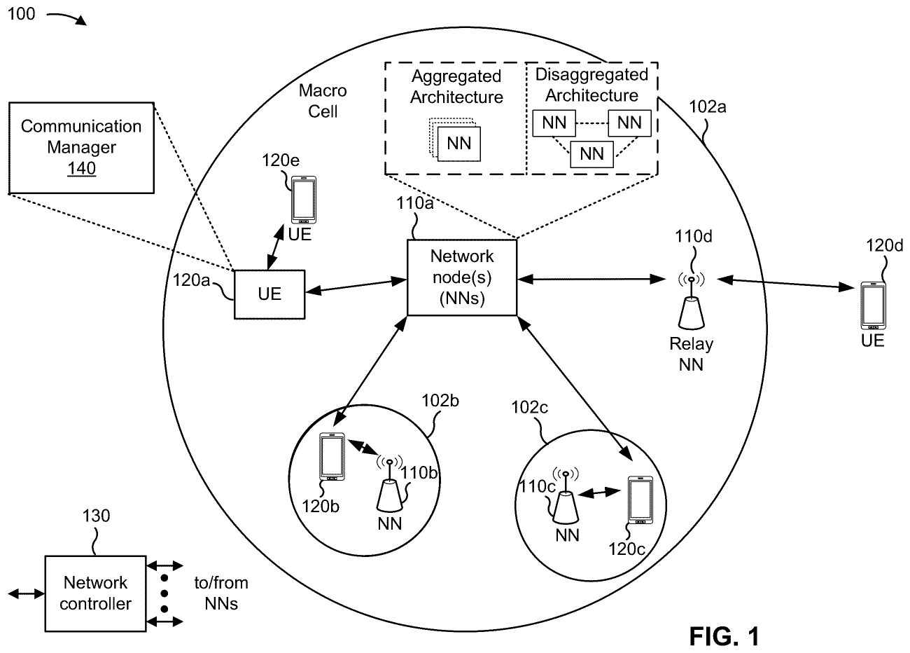

FIG. 1 is a diagram illustrating an example of a wireless network 100. The wireless network 100 may be or may include elements of a 5G (for example, NR) network or a 4G (for example, Long Term Evolution (LTE) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may identify a plurality of beams that are configured for transmitting one or more sidelink communications via one or more sidelink resources; and transmit sidelink control information that indicates to reserve the one or more sidelink resources and that includes an explicit beam indication or a beam hopping indication associated with the plurality of beams. Additionally, or alternatively, the communication manager 140 may perform one or more other operations described herein.

In some aspects, the communication manager 140 may perform one or more measurements associated with a plurality of beams for receiving one or more sidelink communications; and autonomously initiate a beam hopping based at least in part on the one or more measurements and based at least in part on one or more rules or information received from a transmitter UE. Additionally, or alternatively, the communication manager 140 may perform one or more other operations described herein.

As indicated above, FIG. 1 is provided as an example. Other examples may differ from what is described with regard to FIG. 1.

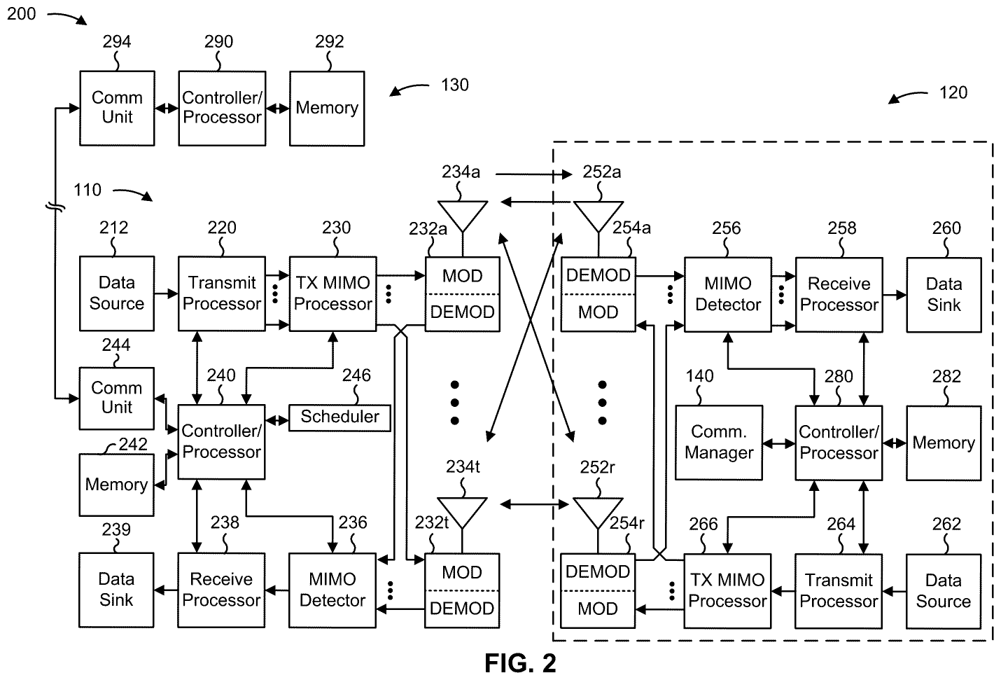

FIG. 2 is a diagram illustrating an example 200 of a network node 110 in communication with a user equipment (UE) 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

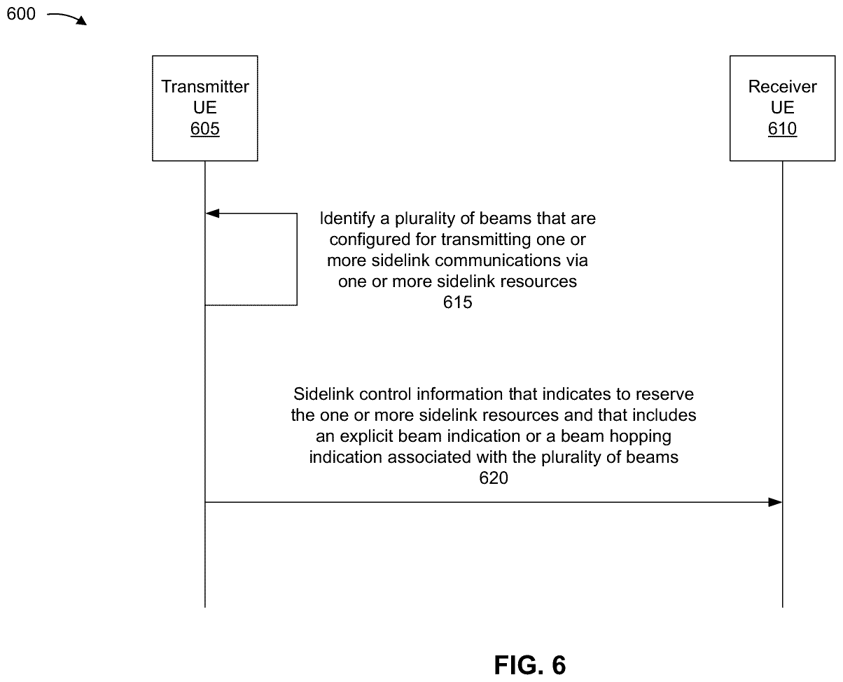

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 6-10).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 6-10).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

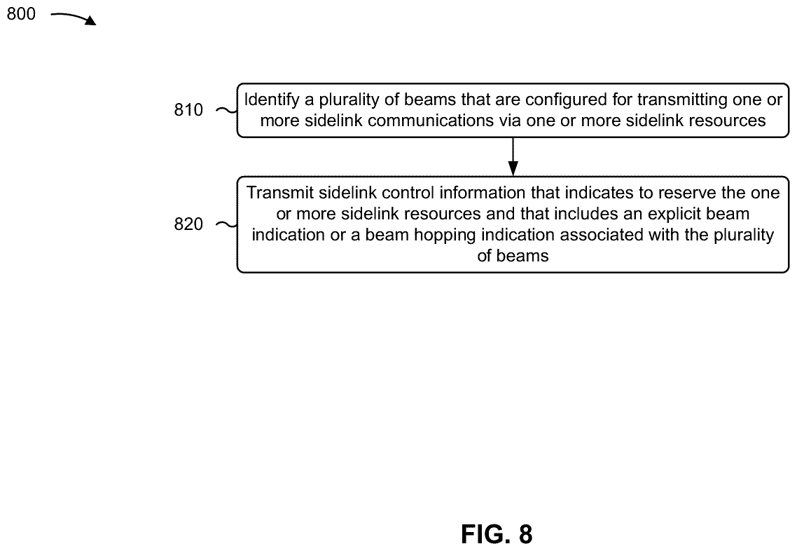

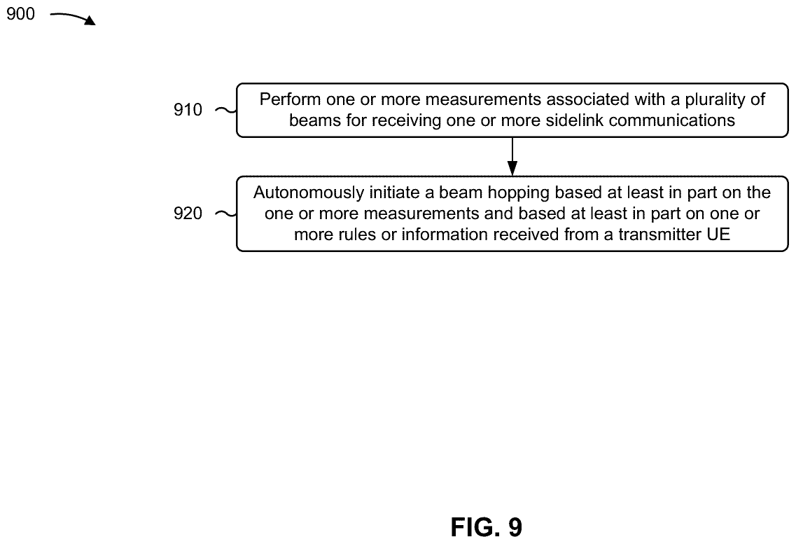

The controller/processor 240 of the network node 110, the controller/processor 280 of the UE 120, or any other component(s) of FIG. 2 may perform one or more techniques associated with sidelink beam hopping, as described in more detail elsewhere herein. For example, the controller/processor 240 of the network node 110, the controller/processor 280 of the UE 120, or any other component(s) (or combinations of components) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for identifying a plurality of beams that are configured for transmitting one or more sidelink communications via one or more sidelink resources; and/or means for transmitting sidelink control information that indicates to reserve the one or more sidelink resources and that includes an explicit beam indication or a beam hopping indication associated with the plurality of beams. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for performing one or more measurements associated with a plurality of beams for receiving one or more sidelink communications; and/or means for autonomously initiating a beam hopping based at least in part on the one or more measurements and based at least in part on one or more rules or information received from a transmitter UE. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

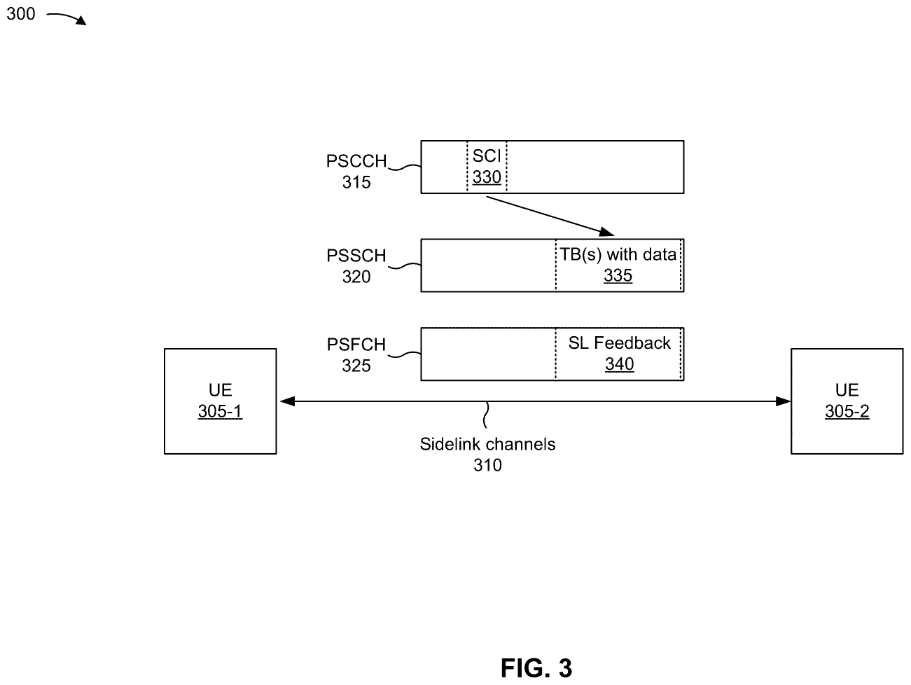

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

In some aspects, a sidelink UE (such as the UE 305) may transmit sidelink control information that includes an explicit beam indication or a beam hopping indication, or may autonomously initiate a beam hopping process, based at least in part on one or more beam measurements. Additional details regarding these features are described herein.

As indicated above, FIG. 3 is provided as an example. Other examples may differ from what is described with respect to FIG. 3.

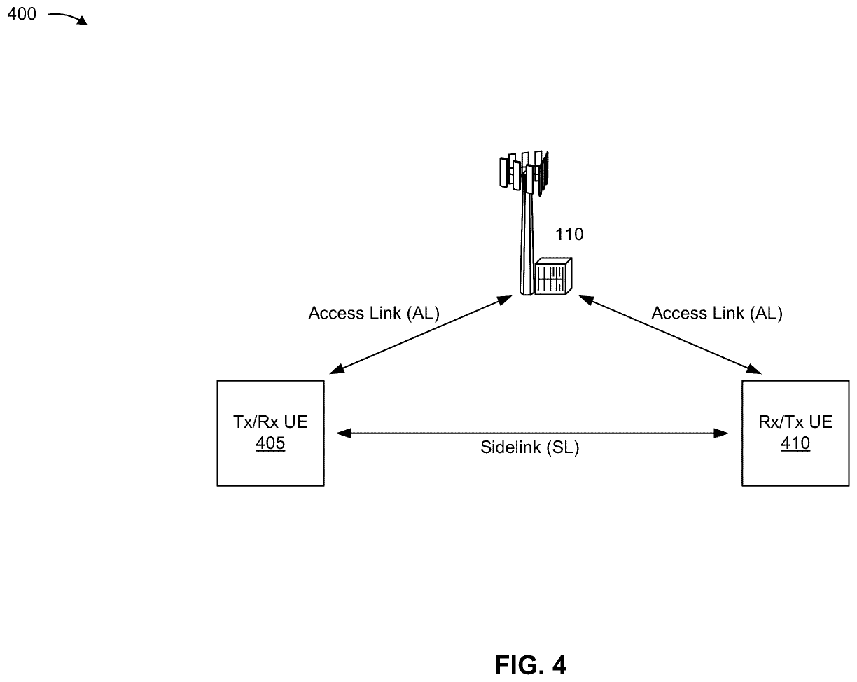

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

In some aspects, a sidelink UE (such as the UE 504 or the UE 410) may transmit sidelink control information that includes an explicit beam indication or a beam hopping indication, or may autonomously initiate a beam hopping process, based at least in part on one or more beam measurements. Additional details regarding these features are described herein.

As indicated above, FIG. 4 is provided as an example. Other examples may differ from what is described with respect to FIG. 4.

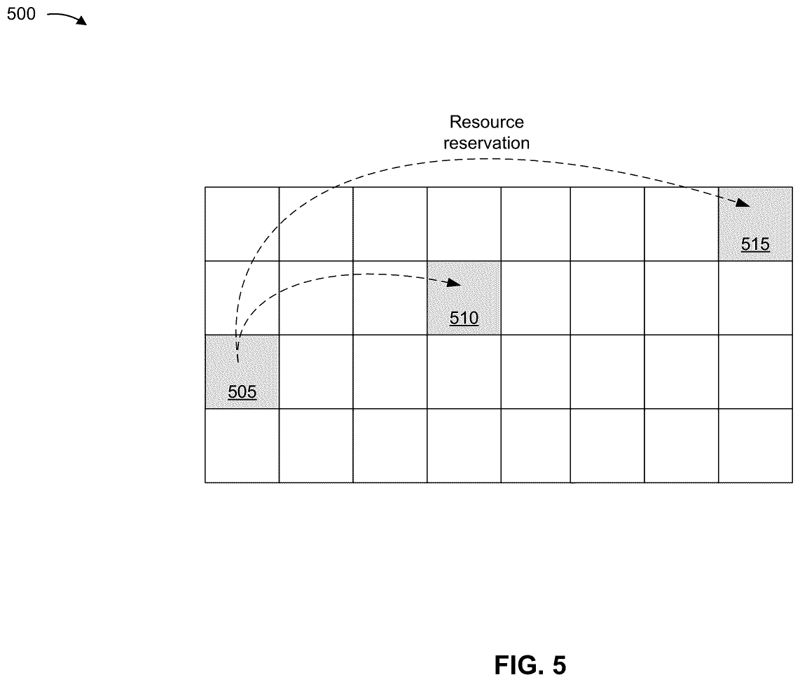

FIG. 5 is a diagram illustrating an example 500 of sidelink resource allocation, in accordance with the present disclosure. As described herein, using Mode 2 resource allocation, the UE 120 may perform resource selection and/or scheduling for sidelink transmissions. In some cases, the UE 120 may perform the resource selection and/or scheduling based at least in part on sensing channel availability for transmissions. For example, the UE 120 may measure an RSSI associated with one or more sidelink channels, an RSRP associated with one or more sidelink channels, and/or an RSRQ associated with one or more sidelink channels, and may select or schedule a channel for transmission of a sidelink communication based at least in part on the measurement(s). This is in contrast to Mode 1 resource allocation, where the resource selection and/or scheduling for the sidelink communication is performed by the network node 110.

In some cases, the UE 120 may perform a first transmission of a sidelink communication (e.g., a packet) using a first resource, such as the resource 505. Additionally, the UE 120 may reserve up to two other resources, such as resource 510 and/or resource 515, for future transmissions, such as one or more retransmissions of the sidelink communication. The channel access and resource reservation by the UE 120 may be based at least in part on the channel sensing described above. For example, the UE 120 may identify a plurality of available resources (candidate resources) for the sidelink communication, and may select one or more of the available resources (such as the resources 505, 510, and 515) to be used for the sidelink communication.

In some cases, the UE 120 may use the same beam for an initial transmission and for future transmissions (e.g., retransmissions). For example, the UE 120 may use a select beam for transmitting a sidelink communication on resource 505, and may use the same select beam for retransmitting the sidelink communication on resource 510 and/or resource 515. However, in some cases, such as due to UE mobility or environmental changes, the current beam (e.g., the beam used for the initial transmission of the sidelink communication) may not be the best beam to be used for future transmissions of the sidelink communication. Instead, it may be better to use one or more other beams for transmitting the sidelink communication at a future time. For example, due to changes in the location of a transmitter UE or a receiver UE (after the initial transmission but prior to the retransmission), the previously activated beam may not be able to reach the transmitter UE or the receiver UE, or may no longer have a directionality that is towards the transmitter UE or the receiver UE. In some cases, the beam may not be strong enough for reserving the future resources using SCI. If the receiver UE does not receive the SCI, the receiver UE may not receive any communications during the sidelink slot. This may result in disrupted communications between the transmitter UE and the receiver UE.

Techniques and apparatuses are described herein for sidelink beam hopping. In some aspects, a transmitter UE may identify a plurality of beams that are configured for transmitting one or more sidelink communications via one or more sidelink resources. The transmitter UE may transmit sidelink control information that indicates to reserve the one or more sidelink resources and that includes an explicit beam indication or a beam hopping indication associated with the plurality of beams. For example, the explicit beam indication may indicate to use a select one or more beams of the plurality of beams for transmitting the one or more sidelink communications. Additionally, or alternatively, the beam hopping indication may indicate to use a select beam hopping pattern associated with the plurality of beams for transmitting the one or more sidelink communications. In some aspects, a receiver UE may perform one or more measurements associated with a plurality of beams for receiving one or more sidelink communications. The receiver UE may initiate (e.g., autonomously initiate) a beam hopping based at least in part on the one or more measurements and based at least in part on one or more rules or information received from a transmitter UE. The receiver UE may transmit a sidelink beam report to the transmitter UE that indicates for the transmitter UE to switch between two or more beams.

As described above, a UE may use the same beam for an initial transmission of a sidelink communication and for future transmissions of the sidelink communication. However, in some cases, such as due to UE mobility or environmental changes, the previously activated sidelink beam may not be the best beam to be used for the future transmissions of the sidelink communication. Instead, it may be better to use one or more other beams for transmitting the sidelink communication at a future time. In some cases, the beam may not be strong enough for reserving the future resources using SCI. If the receiver UE does not receive the SCI, the receiver UE may not receive any communications during the sidelink slot. This may result in disrupted communications between the transmitter UE and the receiver UE. Using the techniques and apparatuses described herein, the transmitter UE may transmit sidelink control information that includes an explicit beam indication or a beam hopping indication associated with the plurality of beams. Additionally, or alternatively, the receiver UE may autonomously initiate a beam hopping based at least in part on one or more beam measurements. Therefore, the transmitter UE and/or the receiver UE may switch beams between an initial transmission of the sidelink communication and one or more future transmissions of the sidelink communication. This may improve the likelihood of the sidelink communication being successfully transmitted and received, thereby resulting in fewer missed or otherwise disrupted communications.

As indicated above, FIG. 5 is provided as an example. Other examples may differ from what is described with respect to FIG. 5.

FIG. 6 is a diagram illustrating an example 600 of sidelink beam hopping, in accordance with the present disclosure. A transmitter UE 605 may communicate with a receiver UE 610. The transmitter UE 605 may include some or all of the features of the UE 120, UE 305, UE 405, and/or UE 410. Additionally, or alternatively, the receiver UE 610 may include some or all of the features of the UE 120, UE 305, UE 405, and/or UE 410.

As shown by reference number 615, the transmitter UE 605 may identify a plurality of beams that are configured for transmitting sidelink communications via one or more sidelink resources. In some aspects, the transmitter UE 605 may perform a plurality of measurements associated with a plurality of beams, and may identify the plurality of beams (or a subset of the plurality of beams) based at least in part on the one or more measurements. The plurality of beams may be candidate beams on which one or more sidelink communications can be transmitted.

In some aspects, the plurality of measurements may include one or more power measurements. For example, the transmitter UE 605 may measure an RSSI, an RSRP, and/or an RSRQ associated with the plurality of beams. The transmitter UE 605 may identify the plurality of beams based at least in part on the one or more measurements. For example, the transmitter UE 605 may identify a plurality of beams having an RSSI that satisfies an acceptable RSSI threshold, an RSRP that satisfies an acceptable RSRP threshold, and/or an RSRQ that satisfies an acceptable RSRQ threshold. In some aspects, the plurality of measurements may include one or more movement-based measurements. For example, the transmitter UE 605 may determine a current location of the transmitter UE 605, or may predict a future location of the transmitter UE 605, such as based at least in part on a current velocity of the transmitter UE 605. Additionally, or alternatively, the transmitter UE 605 may determine a current location of the receiver UE 610, or may predict a future location of the receiver UE 610, such as based at least in part on a current velocity of the receiver UE 610. The transmitter UE 605 may identify one or more beams based at least in part on the current location of the transmitter UE 605, the future location of the transmitter UE 605, the current location of the receiver UE 610, and/or the future location of the receiver UE 610, among other examples. In some aspects, the plurality of measurements may include one or more environment-based measurements. For example, the transmitter UE 605 may identify changes to an environment that includes the transmitter UE 605, an environment that includes the receiver UE 610, and/or an environment within a communication path of the transmitter UE 605 and the receiver UE 610.

As shown by reference number 620, the transmitter UE 605 may transmit sidelink control information that indicates to reserve the one or more sidelink resources and that includes an explicit beam indication or a beam hopping indication associated with the plurality of beams. In some aspects, the sidelink control information may include the explicit beam indication. The explicit beam indication may indicate for the receiver UE 610 to receive a sidelink communication using a select beam of the plurality of beams. In some aspects, the explicit beam indication may indicate to use different beams for different transmissions of the sidelink communication. For example, the explicit beam indication may indicate to use a first beam for receiving a first sidelink communication on a first resource and to use a second beam for receiving a second sidelink communication on a second resource. The second sidelink communication may be a retransmission of the first sidelink communication. In some aspects, the explicit beam indication may indicate to use the first beam, the second beam, or a third beam for receiving a third sidelink communication on a third resource. The third sidelink communication may be another retransmission of the first sidelink communication.

In some aspects, the sidelink control information may include the beam hopping indication. The beam hopping indication may indicate for the receiver UE 610 to switch between the plurality of beams (or a subset of the plurality of beams) for receiving a plurality of sidelink transmissions (or retransmissions). In one example, the plurality of beams may include two beams, and the transmitter UE 605 may indicate to switch between the two beams for receiving two retransmissions of a sidelink communication. Thus, the receiver UE 610 may receive the initial transmission of the sidelink communication on a first resource using a first beam, may receive a first retransmission of the sidelink communication on a second resource using a second beam, and may receive a second retransmission of the sidelink communication on a third resource using the first beam. In some aspects, the beam hopping indication may indicate to implement the beam switching for all future communications between the transmitter UE 605 and the receiver UE 610, or until a next beam hopping indication or is communicated between the transmitter UE 605 and the receiver UE 610. In some other aspects, the beam hopping indication may indicate to implement the beam switching for all communications between the transmitter UE 605 and the receiver UE 610 within a time period. In some aspects, the beam hopping indication may indicate to alternate between the plurality of beams for the sidelink communications. In this case, the receiver UE 610 may switch beams for each reception of a sidelink communication from the transmitter UE 605. In some aspects, the beam hopping indication may indicate an irregular beam hopping pattern, such alternating between two consecutive receptions using the first beam and a single reception using the second beam (e.g., for every three transmissions by the transmitter UE 605). Other beam hopping patterns and configurations considered within the scope of this disclosure. In some aspects, the receiver UE 610 may be configured with a plurality of beam hopping configurations. In this case, transmitting the beam hopping indication may include transmitting an indication of which beam hopping pattern of the plurality of configured beam hopping patterns is to be used.

As described above, a UE may use the same beam for an initial transmission of a sidelink communication and for future transmissions of the sidelink communication. However, in some cases, such as due to UE mobility or environmental changes, the previously activated sidelink beam may not be the best beam to be used for the future transmissions of the sidelink communication. Instead, it may be better to use one or more other beams for transmitting the sidelink communication at a future time. In some cases, the beam may not be strong enough for reserving the future resources using SCI. If the receiver UE 610 does not receive the SCI, the receiver UE 610 may not receive any communications during the sidelink slot. This may result in disrupted communications between the transmitter UE 605 and the receiver UE 610. Using the techniques and apparatuses described herein, the transmitter UE 605 may transmit sidelink control information that includes an explicit beam indication or a beam hopping indication associated with the plurality of beams. Therefore, the transmitter UE 605 and/or the receiver UE 610 may switch beams between an initial transmission of the sidelink communication and one or more future transmissions of the sidelink communication. This may improve the likelihood of the sidelink communication being successfully transmitted and received, thereby resulting in fewer missed or otherwise disrupted communications.

As indicated above, FIG. 6 is provided as an example. Other examples may differ from what is described with respect to FIG. 6.

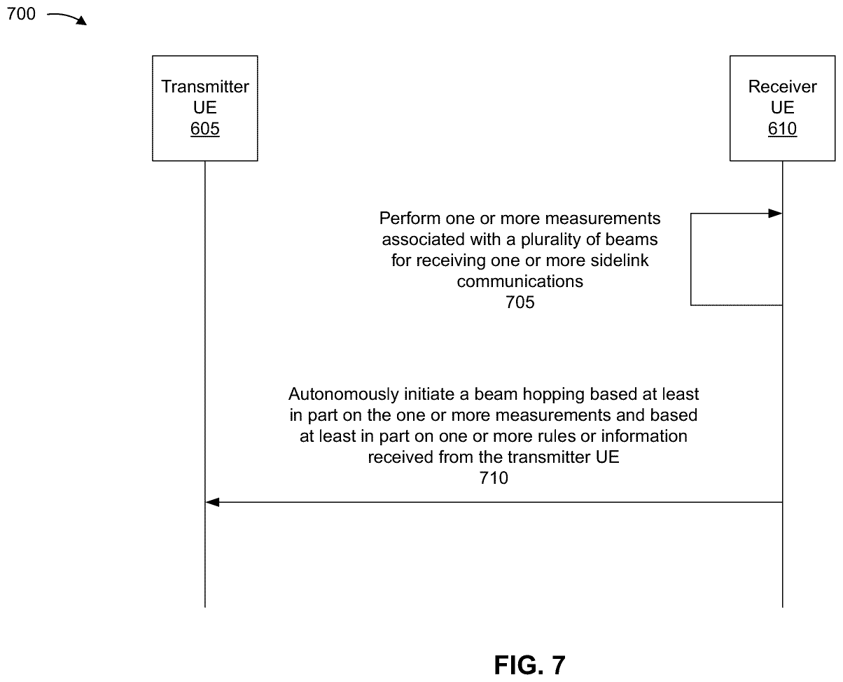

FIG. 7 is a diagram illustrating an example 700 of sidelink beam hopping, in accordance with the present disclosure. As described herein, the transmitter UE 605 may communicate with the receiver UE 610.

As shown by reference number 705, the receiver UE 610 may perform one or more measurements associated with a plurality of beams for receiving one or more sidelink communications. In some aspects, the measurements may include (but are not limited to) one or more RSRP measurements.

As shown by reference number 710, the receiver UE 610 may initiate a beam hopping based at least in part on the one or more measurements and based at least in part on one or more rules or information received from the transmitter UE 605. For example, the receiver UE 610 may autonomously initiate the beam hopping based at least in part on the one or more measurements and based at least in part on the one or more rules or information received from the transmitter UE 605.

In some aspects, a first rule or information (e.g., information received from the transmitter UE 605) may indicate for the receiver UE 610 to initiate the beam hopping based at least in part on RSRP measurements of the plurality of beams, such as all reported beams, not satisfying a first threshold. For example, the first rule or information may indicate for the receiver UE 610 to autonomously initiate the beam hopping based at least in part on the RSRP measurements for the plurality of beams being below X decibels (dB). In this case, the receiver UE 610 may perform RSRP measurements associated with the plurality of beams and may autonomously initiate the beam hopping based at least in part on the RSRP measurements for the plurality of beams being below X dB. In some aspects, a second rule or information may indicate for the receiver UE 610 to initiate the beam hopping based at least in part on a difference between a highest RSRP measurement associated with a beam of the plurality of beams and a second highest RSRP measurement associated with another beam of the plurality of beams not satisfying a second threshold. For example, the second rule or information may indicate for the receiver UE 610 to autonomously initiate the beam hopping based at least in part on the difference between the highest RSRP measurement and the second highest RSRP measurement being less than Y dB. In this case, the receiver UE 610 may perform RSRP measurements associated with the plurality of beams and may autonomously initiate the beam hopping based at least in part on the difference between the highest RSRP measurement and the second highest RSRP measurement being less than Y dB. In some aspects, the receiver UE 610 may initiate the beam hopping based at least in part on a plurality of rules or conditions being satisfied (or not being satisfied). For example, the receiver UE 610 may autonomously initiate the beam hopping based at least in part on the RSRP measurements for the plurality of beams being below X dB and based at least in part on the difference between the highest RSRP measurement and the second highest RSRP measurement being less than Y dB.

In some aspects, the receiver UE 610 may transmit a beam report that indicates for the transmitter UE 605 to enable the beam hopping. For example, one or more bits in the beam report may indicate for the transmitter UE 605 to enable the beam hopping. In some aspects, the receiver UE 610 and the transmitter UE 605 may communicate information that indicates a select beam hopping pattern or a plurality of beam hopping patterns. For example, the receiver UE 610 may transmit sidelink radio resource control (RRC) information or a sidelink medium access control (MAC) message (such as a sidelink MAC control element (MAC-CE)) that indicates the select beam hopping pattern or the plurality of beam hopping patterns. In some aspects, if the transmitter UE 605 does not receive the beam report, the transmitter UE 605 may communicate with the receiver UE 610 using the current beam.

In some aspects, the receiver UE 610 may transmit a beam report that indicates an RSRP measurement associated with a current beam (e.g., a beam currently used for communicating between the transmitter UE 605 and the receiver UE 610) and an RSRP measurement associated with another beam (or a plurality of other beams). In some aspects, the beam report may indicate one or more beam switching or beam hopping actions to be taken by the transmitter UE 605. For example, based at least in part on the beam report, the transmitter UE 605 may not initiate any beam switching or beam hopping, may switch to another beam, may initiate a first beam hopping process that includes the current beam, or may initiate a second beam hopping process that does not include the current beam, among other examples. In some aspects, the transmitter UE 605 may selectively initiate a beam switching or beam hopping based at least in part on signaling received from the receiver UE 610 and/or based at least in part on one or more rules. In one example, if no other beam measurement is X dB greater than a current beam measurement, or if the current beam measurement is greater than all of the other beam measurements by W dB, the transmitter UE 605 may not perform any beam switching or beam hopping. In another example, if the best (e.g., highest) beam measurement is X dB greater than the current beam measurement, and the best beam measurement is greater than Y dB, the transmitter UE 605 may switch to the best beam. In another example, if the current beam measurement is less than Z dB, and no other beam measurement is X′ dB greater than the current beam measurement, the transmitter UE 605 may initiate a beam hopping, such as the first beam hopping process or the second beam hopping process described above.

As described above, a UE may use the same beam for an initial transmission of a sidelink communication and for future transmissions of the sidelink communication. However, in some cases, such as due to UE mobility or environmental changes, the previously activated sidelink beam may not be the best beam to be used for the future transmissions of the sidelink communication. Instead, it may be better to use one or more other beams for transmitting the sidelink communication at a future time. In some cases, the beam may not be strong enough for reserving the future resources using SCI. If the receiver UE 610 does not receive the SCI, the receiver UE 610 may not receive any communications during the sidelink slot. This may result in disrupted communications between the transmitter UE 605 and the receiver UE 610. Using the techniques and apparatuses described herein, the receiver UE 610 may autonomously initiate a beam hopping based at least in part on one or more beam measurements. Therefore, the transmitter UE 605 and/or the receiver UE 610 may switch beams between an initial transmission of the sidelink communication and one or more future transmissions of the sidelink communication. This may improve the likelihood of the sidelink communication being successfully transmitted and received, thereby resulting in fewer missed or otherwise disrupted communications.

As indicated above, FIG. 7 is provided as an example. Other examples may differ from what is described with respect to FIG. 7.

FIG. 8 is a diagram illustrating an example process 800 performed, for example, by a transmitter UE, in accordance with the present disclosure. Example process 800 is an example where the UE (e.g., UE 120) performs operations associated with sidelink beam hopping.

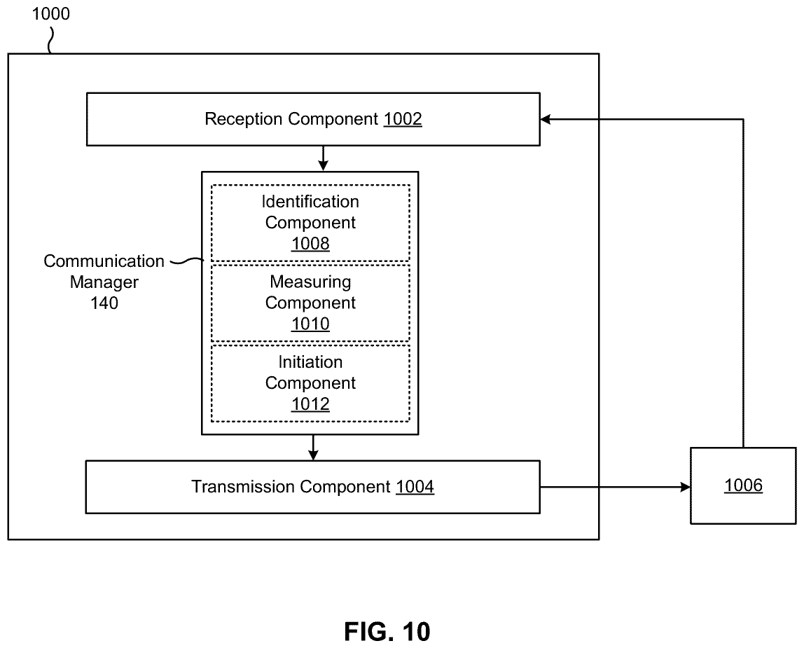

As shown in FIG. 8, in some aspects, process 800 may include identifying a plurality of beams that are configured for transmitting one or more sidelink communications via one or more sidelink resources (block 810). For example, the UE (e.g., using communication manager 140 and/or identification component 1008, depicted in FIG. 10) may identify a plurality of beams that are configured for transmitting one or more sidelink communications via one or more sidelink resources, as described above.

As further shown in FIG. 8, in some aspects, process 800 may include transmitting sidelink control information that indicates to reserve the one or more sidelink resources and that includes an explicit beam indication or a beam hopping indication associated with the plurality of beams (block 820). For example, the UE (e.g., using communication manager 140 and/or transmission component 1004, depicted in FIG. 10) may transmit sidelink control information that indicates to reserve the one or more sidelink resources and that includes an explicit beam indication or a beam hopping indication associated with the plurality of beams, as described above.

Process 800 may include additional aspects, such as any single aspect or any combination of aspects described below and/or in connection with one or more other processes described elsewhere herein.

In a first aspect, process 800 includes performing one or more measurements associated with the plurality of beams, wherein transmitting the sidelink control information comprises transmitting the sidelink control information based at least in part on the one or more measurements.

In a second aspect, alone or in combination with the first aspect, the one or more measurements include at least one of a reference signal received power measurement, a movement-based measurement associated with a movement by the transmitter UE or a receiver UE, or an environment-based measurement associated with an environment that includes the transmitter UE or the receiver UE.

In a third aspect, alone or in combination with one or more of the first and second aspects, the explicit beam indication indicates to use a select one or more beams of the plurality of beams for transmitting the one or more sidelink communications.

In a fourth aspect, alone or in combination with one or more of the first through third aspects, the beam hopping indication indicates to use a select beam hopping pattern associated with the plurality of beams for transmitting the one or more sidelink communications.

In a fifth aspect, alone or in combination with one or more of the first through fourth aspects, transmitting the sidelink control information that indicates to reserve the one or more sidelink resources comprises transmitting sidelink control information that indicates to reserve a first sidelink resource for transmitting a first sidelink communication and to reserve a second sidelink resource for transmitting a second sidelink communication.

In a sixth aspect, alone or in combination with one or more of the first through fifth aspects, the explicit beam indication indicates to use a first beam for transmitting the first sidelink communication via the first sidelink resource and to use a second beam for transmitting the second sidelink communication via the second sidelink resource.

In a seventh aspect, alone or in combination with one or more of the first through sixth aspects, the beam hopping indication indicates to use a select beam hopping pattern for switching between a first beam and a second beam for transmitting the first sidelink communication and the second sidelink communication.

In an eighth aspect, alone or in combination with one or more of the first through seventh aspects, the second sidelink communication is a retransmission of the first sidelink communication.

In a ninth aspect, alone or in combination with one or more of the first through eighth aspects, the sidelink control information that includes the explicit beam indication or the beam hopping indication indicates for a receiver UE to use a select one or more beams or a select beam hopping pattern for receiving the one or more sidelink communications.

In a tenth aspect, alone or in combination with one or more of the first through ninth aspects, transmitting the sidelink control information comprises transmitting first sidelink control information that indicates to reserve the one or more sidelink resources and transmitting second sidelink control information that includes the explicit beam indication or the beam hopping indication.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a receiver UE, in accordance with the present disclosure. Example process 900 is an example where the UE (e.g., UE 120) performs operations associated with sidelink beam hopping.

As shown in FIG. 9, in some aspects, process 900 may include performing one or more measurements associated with a plurality of beams for receiving one or more sidelink communications (block 910). For example, the UE (e.g., using communication manager 140 and/or measuring component 1010, depicted in FIG. 10) may perform one or more measurements associated with a plurality of beams for receiving one or more sidelink communications, as described above.

As further shown in FIG. 9, in some aspects, process 900 may include autonomously initiating a beam hopping based at least in part on the one or more measurements and based at least in part on one or more rules or information received from a transmitter UE (block 920). For example, the UE (e.g., using communication manager 140 and/or initiation component 1012, depicted in FIG. 10) may autonomously initiate a beam hopping based at least in part on the one or more measurements and based at least in part on one or more rules or information received from a transmitter UE, as described above.

Process 900 may include additional aspects, such as any single aspect or any combination of aspects described below and/or in connection with one or more other processes described elsewhere herein.

In a first aspect, the one or more measurements comprise one or more RSRP measurements.

In a second aspect, alone or in combination with the first aspect, a select rule of the one or more rules indicates to autonomously initiate the beam hopping based at least in part on a plurality of RSRP measurements associated with a plurality of beams not satisfying a first threshold, or based at least in part on a difference between a highest RSRP measurement and a next highest RSRP measurement, of the plurality of RSRP measurements, not satisfying a second threshold.

In a third aspect, alone or in combination with one or more of the first and second aspects, process 900 includes communicating a sidelink radio resource control message or a sidelink medium access control message that includes an indication of a beam hopping pattern.

In a fourth aspect, alone or in combination with one or more of the first through third aspects, autonomously initiating the beam hopping comprises transmitting a sidelink beam report to the transmitter UE that indicates for the transmitter UE to switch between two or more beams.

In a fifth aspect, alone or in combination with one or more of the first through fourth aspects, the sidelink beam report includes one or more bits that indicate for the transmitter UE to switch between the two or more beams.

In a sixth aspect, alone or in combination with one or more of the first through fifth aspects, the sidelink beam report indicates for the transmitter UE to switch between the two or more beams based at least in part on a RSRP measurement associated with a current beam and an RSRP measurement associated with another beam.

In a seventh aspect, alone or in combination with one or more of the first through sixth aspects, the sidelink beam report indicates for the transmitter UE to switch from the current beam to the other beam or to initiate a beam hopping using a select beam hopping mode.

In an eighth aspect, alone or in combination with one or more of the first through seventh aspects, the select beam hopping mode is a first beam hopping mode that includes beam hopping that uses the current beam or a second beam hopping mode that includes beam hopping that does not use the current beam.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of an identification component 1008, a measuring component 1010, or an initiation component 1012, among other examples.

In some aspects, the apparatus 1000 may be configured to perform one or more operations described herein in connection with FIGS. 6-7. Additionally, or alternatively, the apparatus 1000 may be configured to perform one or more processes described herein, such as process 800 of FIG. 8, process 900 of FIG. 9, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The identification component 1008 may identify a plurality of beams that are configured for transmitting one or more sidelink communications via one or more sidelink resources. The transmission component 1004 may transmit sidelink control information that indicates to reserve the one or more sidelink resources and that includes an explicit beam indication or a beam hopping indication associated with the plurality of beams. The measuring component 1010 may perform one or more measurements associated with the plurality of beams, wherein transmitting the sidelink control information comprises transmitting the sidelink control information based at least in part on the one or more measurements.

The measuring component 1010 may perform one or more measurements associated with a plurality of beams for receiving one or more sidelink communications. The initiation component 1012 may autonomously initiate a beam hopping based at least in part on the one or more measurements and based at least in part on one or more rules or information received from a transmitter UE. The reception component 1002 and/or the transmission component 1004 may communicate a sidelink radio resource control message or a sidelink medium access control message that includes an indication of a beam hopping pattern.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a transmitter user equipment (UE), comprising: identifying a plurality of beams that are configured for transmitting one or more sidelink communications via one or more sidelink resources; and transmitting sidelink control information that indicates to reserve the one or more sidelink resources and that includes an explicit beam indication or a beam hopping indication associated with the plurality of beams.

Aspect 2: The method of Aspect 1, further comprising performing one or more measurements associated with the plurality of beams, wherein transmitting the sidelink control information comprises transmitting the sidelink control information based at least in part on the one or more measurements.

Aspect 3: The method of Aspect 2, wherein the one or more measurements include at least one of a reference signal received power measurement, a movement-based measurement associated with a movement by the transmitter UE or a receiver UE, or an environment-based measurement associated with an environment that includes the transmitter UE or the receiver UE.

Aspect 4: The method of any of Aspects 1-3, wherein the explicit beam indication indicates to use a select one or more beams of the plurality of beams for transmitting the one or more sidelink communications.

Aspect 5: The method of any of Aspects 1-4, wherein the beam hopping indication indicates to use a select beam hopping pattern associated with the plurality of beams for transmitting the one or more sidelink communications.

Aspect 6: The method of any of Aspects 1-5, wherein transmitting the sidelink control information that indicates to reserve the one or more sidelink resources comprises transmitting sidelink control information that indicates to reserve a first sidelink resource for transmitting a first sidelink communication and to reserve a second sidelink resource for transmitting a second sidelink communication.

Aspect 7: The method of Aspect 6, wherein the explicit beam indication indicates to use a first beam for transmitting the first sidelink communication via the first sidelink resource and to use a second beam for transmitting the second sidelink communication via the second sidelink resource.

Aspect 8: The method of Aspect 6, wherein the beam hopping indication indicates to use a select beam hopping pattern for switching between a first beam and a second beam for transmitting the first sidelink communication and the second sidelink communication.

Aspect 9: The method of Aspect 6, wherein the second sidelink communication is a retransmission of the first sidelink communication.

Aspect 10: The method of any of Aspects 1-9, wherein the sidelink control information that includes the explicit beam indication or the beam hopping indication indicates for a receiver UE to use a select one or more beams or a select beam hopping pattern for receiving the one or more sidelink communications.

Aspect 11: The method of any of Aspects 1-10, wherein transmitting the sidelink control information comprises transmitting first sidelink control information that indicates to reserve the one or more sidelink resources and transmitting second sidelink control information that includes the explicit beam indication or the beam hopping indication.

Aspect 12: A method of wireless communication performed by a receiver user equipment (UE), comprising: performing one or more measurements associated with a plurality of beams for receiving one or more sidelink communications; and autonomously initiating a beam hopping based at least in part on the one or more measurements and based at least in part on one or more rules or information received from a transmitter UE.

Aspect 13: The method of Aspect 12, wherein the one or more measurements comprise one or more reference signal received power (RSRP) measurements.

Aspect 14: The method of Aspect 13, wherein a select rule of the one or more rules indicates to autonomously initiate the beam hopping based at least in part on a plurality of RSRP measurements associated with a plurality of beams not satisfying a first threshold, or based at least in part on a difference between a highest RSRP measurement and a next highest RSRP measurement, of the plurality of RSRP measurements, not satisfying a second threshold.

Aspect 15: The method of any of Aspects 12-14, further comprising communicating a sidelink radio resource control message or a sidelink medium access control message that includes an indication of a beam hopping pattern.

Aspect 16: The method of any of Aspects 12-15, wherein autonomously initiating the beam hopping comprises transmitting a sidelink beam report to the transmitter UE that indicates for the transmitter UE to switch between two or more beams.

Aspect 17: The method of Aspect 16, wherein the sidelink beam report includes one or more bits that indicate for the transmitter UE to switch between the two or more beams.

Aspect 18: The method of Aspect 16, wherein the sidelink beam report indicates for the transmitter UE to switch between the two or more beams based at least in part on a reference signal received power (RSRP) measurement associated with a current beam and an RSRP measurement associated with another beam.

Aspect 19: The method of Aspect 18, wherein the sidelink beam report indicates for the transmitter UE to switch from the current beam to the other beam or to initiate a beam hopping using a select beam hopping mode.

Aspect 20: The method of Aspect 19, wherein the select beam hopping mode is a first beam hopping mode that includes beam hopping that uses the current beam or a second beam hopping mode that includes beam hopping that does not use the current beam.

Aspect 21: An apparatus for wireless communication at a device, comprising a processor; memory coupled with the processor; and instructions stored in the memory and executable by the processor to cause the apparatus to perform the method of one or more of Aspects 1-15.

Aspect 22: A device for wireless communication, comprising a memory and one or more processors coupled to the memory, the one or more processors configured to perform the method of one or more of Aspects 1-15.

Aspect 23: An apparatus for wireless communication, comprising at least one means for performing the method of one or more of Aspects 1-15.

Aspect 24: A non-transitory computer-readable medium storing code for wireless communication, the code comprising instructions executable by a processor to perform the method of one or more of Aspects 1-15.

Aspect 25: A non-transitory computer-readable medium storing a set of instructions for wireless communication, the set of instructions comprising one or more instructions that, when executed by one or more processors of a device, cause the device to perform the method of one or more of Aspects 1-15.

Aspect 26: An apparatus for wireless communication at a device, comprising a processor; memory coupled with the processor; and instructions stored in the memory and executable by the processor to cause the apparatus to perform the method of one or more of Aspects 16-20.

Aspect 27: A device for wireless communication, comprising a memory and one or more processors coupled to the memory, the one or more processors configured to perform the method of one or more of Aspects 16-20.

Aspect 28: An apparatus for wireless communication, comprising at least one means for performing the method of one or more of Aspects 16-20.

Aspect 29: A non-transitory computer-readable medium storing code for wireless communication, the code comprising instructions executable by a processor to perform the method of one or more of Aspects 16-20.

Aspect 30: A non-transitory computer-readable medium storing a set of instructions for wireless communication, the set of instructions comprising one or more instructions that, when executed by one or more processors of a device, cause the device to perform the method of one or more of Aspects 16-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication at a transmitter user equipment (UE), comprising:
a memory; and
one or more processors, coupled to the memory, configured to:
identify a plurality of beams that are configured for transmitting one or more sidelink communications via one or more sidelink resources; and
transmit sidelink control information that indicates to reserve the one or more sidelink resources and that includes an explicit beam indication or a beam hopping indication associated with the plurality of beams.

2. The apparatus of claim 1, wherein the one or more processors are further configured to perform one or more measurements associated with the plurality of beams, wherein transmitting the sidelink control information comprises transmitting the sidelink control information based at least in part on the one or more measurements.

3. The apparatus of claim 2, wherein the one or more measurements include at least one of a reference signal received power measurement, a movement-based measurement associated with a movement by the transmitter UE or a receiver UE, or an environment-based measurement associated with an environment that includes the transmitter UE or the receiver UE.

4. The apparatus of claim 1, wherein the explicit beam indication indicates to use a select one or more beams of the plurality of beams for transmitting the one or more sidelink communications.

5. The apparatus of claim 1, wherein the beam hopping indication indicates to use a select beam hopping pattern associated with the plurality of beams for transmitting the one or more sidelink communications.

6. The apparatus of claim 1, wherein the one or more processors, to transmit the sidelink control information that indicates to reserve the one or more sidelink resources, are configured to transmit sidelink control information that indicates to reserve a first sidelink resource for transmitting a first sidelink communication and to reserve a second sidelink resource for transmitting a second sidelink communication.

7. The apparatus of claim 6, wherein the explicit beam indication indicates to use a first beam for transmitting the first sidelink communication via the first sidelink resource and to use a second beam for transmitting the second sidelink communication via the second sidelink resource.

8. The apparatus of claim 6, wherein the beam hopping indication indicates to use a select beam hopping pattern for switching between a first beam and a second beam for transmitting the first sidelink communication and the second sidelink communication.

9. The apparatus of claim 6, wherein the second sidelink communication is a retransmission of the first sidelink communication.

10. The apparatus of claim 1, wherein the sidelink control information that includes the explicit beam indication or the beam hopping indication indicates for a receiver UE to use a select one or more beams or a select beam hopping pattern for receiving the one or more sidelink communications.

11. The apparatus of claim 1, wherein the one or more processors, to transmit the sidelink control information, are configured to transmit first sidelink control information that indicates to reserve the one or more sidelink resources and transmit second sidelink control information that includes the explicit beam indication or the beam hopping indication.

12. An apparatus for wireless communication at a receiver user equipment (UE), comprising:
a memory; and
one or more processors, coupled to the memory, configured to:
perform one or more measurements associated with a plurality of beams for receiving one or more sidelink communications; and
autonomously initiate a beam hopping based at least in part on the one or more measurements and based at least in part on one or more rules or information received from a transmitter UE.

13. The apparatus of claim 12, wherein the one or more measurements comprise one or more reference signal received power (RSRP) measurements.

14. The apparatus of claim 13, wherein a select rule of the one or more rules indicates to autonomously initiate the beam hopping based at least in part on a plurality of RSRP measurements associated with a plurality of beams not satisfying a first threshold, or based at least in part on a difference between a highest RSRP measurement and a next highest RSRP measurement, of the plurality of RSRP measurements, not satisfying a second threshold.

15. The apparatus of claim 12, wherein the one or more processors are further configured to communicate a sidelink radio resource control message or a sidelink medium access control message that includes an indication of a beam hopping pattern.

16. The apparatus of claim 12, wherein the one or more processors, to autonomously initiate the beam hopping, are configured to transmit a sidelink beam report to the transmitter UE that indicates for the transmitter UE to switch between two or more beams.

17. The apparatus of claim 16, wherein the sidelink beam report includes one or more bits that indicate for the transmitter UE to switch between the two or more beams.

18. The apparatus of claim 16, wherein the sidelink beam report indicates for the transmitter UE to switch between the two or more beams based at least in part on a reference signal received power (RSRP) measurement associated with a current beam and an RSRP measurement associated with another beam.

19. The apparatus of claim 18, wherein the sidelink beam report indicates for the transmitter UE to switch from the current beam to the other beam or to initiate a beam hopping using a select beam hopping mode.

20. The apparatus of claim 19, wherein the select beam hopping mode is a first beam hopping mode that includes beam hopping that uses the current beam or a second beam hopping mode that includes beam hopping that does not use the current beam.

21. A method of wireless communication performed by a transmitter user equipment (UE), comprising:
identifying a plurality of beams that are configured for transmitting one or more sidelink communications via one or more sidelink resources; and
transmitting sidelink control information that indicates to reserve the one or more sidelink resources and that includes an explicit beam indication or a beam hopping indication associated with the plurality of beams.

22. The method of claim 21, further comprising performing one or more measurements associated with the plurality of beams, wherein transmitting the sidelink control information comprises transmitting the sidelink control information based at least in part on the one or more measurements.

23. The method of claim 22, wherein the one or more measurements include at least one of a reference signal received power measurement, a movement-based measurement associated with a movement by the transmitter UE or a receiver UE, or an environment-based measurement associated with an environment that includes the transmitter UE or the receiver UE.

24. The method of claim 21, wherein the explicit beam indication indicates to use a select one or more beams of the plurality of beams for transmitting the one or more sidelink communications.

25. The method of claim 21, wherein the beam hopping indication indicates to use a select beam hopping pattern associated with the plurality of beams for transmitting the one or more sidelink communications.

26. The method of claim 21, wherein transmitting the sidelink control information that indicates to reserve the one or more sidelink resources comprises transmitting sidelink control information that indicates to reserve a first sidelink resource for transmitting a first sidelink communication and to reserve a second sidelink resource for transmitting a second sidelink communication.

27. A method of wireless communication performed by a receiver user equipment (UE), comprising:
performing one or more measurements associated with a plurality of beams for receiving one or more sidelink communications; and
autonomously initiating a beam hopping based at least in part on the one or more measurements and based at least in part on one or more rules or information received from a transmitter UE.

28. The method of claim 27, wherein the one or more measurements comprise one or more reference signal received power (RSRP) measurements.

29. The method of claim 28, wherein a select rule of the one or more rules indicates to autonomously initiate the beam hopping based at least in part on a plurality of RSRP measurements associated with a plurality of beams not satisfying a first threshold, or based at least in part on a difference between a highest RSRP measurement and a next highest RSRP measurement, of the plurality of RSRP measurements, not satisfying a second threshold.

30. The method of claim 27, wherein autonomously initiating the beam hopping comprises transmitting a sidelink beam report to the transmitter UE that indicates for the transmitter UE to switch between two or more beams.
